(19) United States
(12) Patent Application Publication
(10) Pub. No.: US 2018/0284880 A1
(43) Pub. Date: Oct. 4, 2018

(54) CONTROLLING A VEHICLE-BASED HUMAN-MACHINE INTERFACE VIA A WEARABLE DEVICE

(71) Applicant: Nazih K. Hijaouy, Plymouth, MI (US)

(72) Inventor: Nazih K. Hijaouy, Plymouth, MI (US)

(21) Appl. No.: 15/474,161

(22) Filed: Mar. 30, 2017

(51) Int. Cl. G06F 3/01; H04L 29/08; G06F 1/16; G06F 3/16

(52) U.S. Cl. CPC G06F 3/011; G06F 3/167; G06F 1/163; H04L 67/12

(57) ABSTRACT

Methods, systems, and circuits are provided herein that allow a human-machine interface (HMI) for a vehicle electronics system to be controlled via a wearable device. The control, via the wearable device, may interact with the vehicle control system, and further, with a mobile device network paired to the vehicle electronics system.

### BACKGROUND

Vehicles have traditionally been provided with interfaces that allow a driver or passenger to interact with the vehicle. The interactions cause various vehicle componentry, such as entertainment systems, climate control systems, navigation systems, and the like to provide information or change state of the vehicle. These interfaces have traditionally been mechanical in nature.

In recent times, mechanical interfaces have been either augmented or replaced with electronic interfaces such as touch surfaces or screens, gaze trackers, gesture trackers, and the like. Collectively, these mechanical and electrical interfaces are referred to as human-machine interfaces (HMI). Implementers of vehicle components introduce HMI systems and devices so that user-experience, user safety and user convenience are all optimized.

Further, vehicles are being provided with technology to pair or connect portable electronic devices to the vehicle's electronic system. Accordingly, once the portable electronic device is paired (i.e., sharing information either in a wired or wireless manner) with the vehicle's electronic system, the driver or passenger may control the portable electronic device through the vehicle's HMI.

Another portable/mobile type of technology device is wearable technology devices (or just wearable devices). Wearable technology devices are electronic devices communicable (for example, wirelessly) to other electronic devices. Several examples of wearable technology devices are a smart watch, electronic rings, electronic bracelets, and the like.

These devices are equipped with wireless communication capabilities, and as such, may communicate with other electronic systems. Often times, the wearable technology device is coupled to a biometric function, and may detect an aspect of the wearer's physiology.

In other cases, the wearable technology device may be an information providing device, and be coupled to a network connection (e.g. a cloud storage device, satellite connection, wireless internet, short range communication protocol, or the like), and communicate the information to the wearer of the wearable technology device.

In recent years, the vehicle has become more electronic and interactive. Vehicle technology has been designed to incorporate various ideas and concepts associated with mobile computing and a connected vehicle.

For example, infotainment systems provided in a vehicle may be provided or installed in a vehicle cluster. The infotainment system may be configured to provide entertainment via a display, or alternatively, provide useful information about the vehicle's operation. The infotainment system may be configured to handshake with a mobile device, and share information to and from the driver or passenger. For example, media stored on the mobile device may be transmitted to the infotainment system.

### SUMMARY

The following description relates to system, methods, and circuits related to the control of a vehicular HMI system via a wearable device, and further control to secondary devices paired (via a network) to the vehicle control system. Exemplary embodiments may also be directed to any of the system, the method, or an application provided on an instrument cluster, electronic vehicle system, a wearable device, or the like.

Additional features of the invention will be set forth in the description which follows, and in part will be apparent from the description, or may be learned by practice of the invention.

Disclosed herein is a system for providing a vehicle-based human-machine interface (HMI) via a wearable device. The system includes a vehicle microprocessor network connected to the wearable device and a mobile device; a data store comprising a non-transitory computer readable medium storing a program of instructions for the providing; a processor that executes the program of instructions, the instruction comprising the following steps: via the mobile device, initializing an action associated with a prompt; via the mobile device, communicating data associated with the prompt to the vehicle control system; via the vehicle processor, determining whether the prompt in the data is communicable to the wearable device; via the vehicle processor, and in response to the determination being yes, communicating the data to the wearable device; via the wearable device, receiving an input in response to the prompt, and via the wearable device, communicating the received input.

In another example, the system includes a first application installed on the vehicle processor and a second application installed on the wearable device, wherein the program instructions performed via the vehicle processor and integrated into the first application, and the program instructions performed via the wearable device are integrated into the second application.

In another example, the prompt is generated in response to the mobile device receiving a call, and the prompt is further defined as whether to answer the call.

In another example, the program of instructions further comprises changing a mode of the wearable device to enter a sensing mode in response to the communication of data to the wearable device.

In another example, the system further includes a human-machine interface (HMI) display electronically coupled to the vehicle processor; after entering the sensing mode, simultaneously displaying via the HMI instructions on interacting with the wearable device to respond to the prompt.

In another example, the response to the prompt is defined as a number of taps on a screen associated with the wearable device.

In another example, the response to the prompt is defined as a vocal input.

In another example, the response to the prompt is defined as a movement of an appendage on which the wearable device is worn on.

In another example, the communication of the received input is defined as a communication to the mobile device, via the vehicle processor.

In another example, the communication of the received input is defined as a communication to the mobile device directly through a pairing connection established via the wearable device and the mobile device.

Also disclosed is a system for controlling a vehicle-based human-machine interface (HMI) via wearable technology. The system includes a vehicle microprocessor network connected to the wearable technology and a mobile device; a data store comprising a non-transitory computer readable medium storing a program of instructions for the controlling; a processor that executes the program of instructions, the instruction comprising the following steps: receiving from a vehicle processor, data associated with a prompt; providing an interface technique with the wearable device to answer the prompt; and communicating an answer via the interface technique to the vehicle processor.

Also disclosed is a system for modifying a vehicle processor to allow control via a wearable device. The system includes a vehicle microprocessor network connected to the wearable device and a mobile device; a data store comprising a non-transitory computer readable medium storing a program of instructions for the providing. The system includes an application installed on the wearable device that has been modified so that the program of instructions to execute via the vehicle processor to further comprise the following steps: in response to the vehicle processor receiving data requesting an answer to a prompt, determining whether the wearable device is employable to provide the answer; in response to the determination being yes, communicating the data including the prompt to the wearable device; and receiving data from the wearable device including the answer to the prompt.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of a vehicle electronic system according to exemplary aspects disclosed herein.

FIG. 2 illustrates a method of implementing aspects associated with the modifications described in FIG. 1 according to the aspects disclosed herein.

FIG. 3 illustrates a first embodiment describing the method in FIG. 2.

FIG. 4 illustrates a first embodiment describing the method in FIG. 2.

FIGS. 5A-5C illustrate an example implementation of the aspects described herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As portable technology (such as mobile devices and wearable devices) become more commonplace, existing vehicle HMI's fail to encompass the complete capabilities of interacting with the vehicle. As such, while several HMI options are available, the driver or passenger may not realize all the available ways to interact with the vehicle.

Disclosed herein are methods, systems, and electronic circuits configured to allow interaction between a wearable device, a vehicle electronic system, and a mobile device in a manner that improves a user-experience in the field of vehicle-based HMI systems. The vehicle electronic system may be, for example, a vehicle infotainment system. Vehicle infotainment systems are often installed in a dashboard area of a vehicle, and allow interaction with the driver and/or passenger in a manner to allow control of various electronic systems. Alternatively, the vehicle electronic system may be embedded in the vehicle cockpit, and not completely visible.

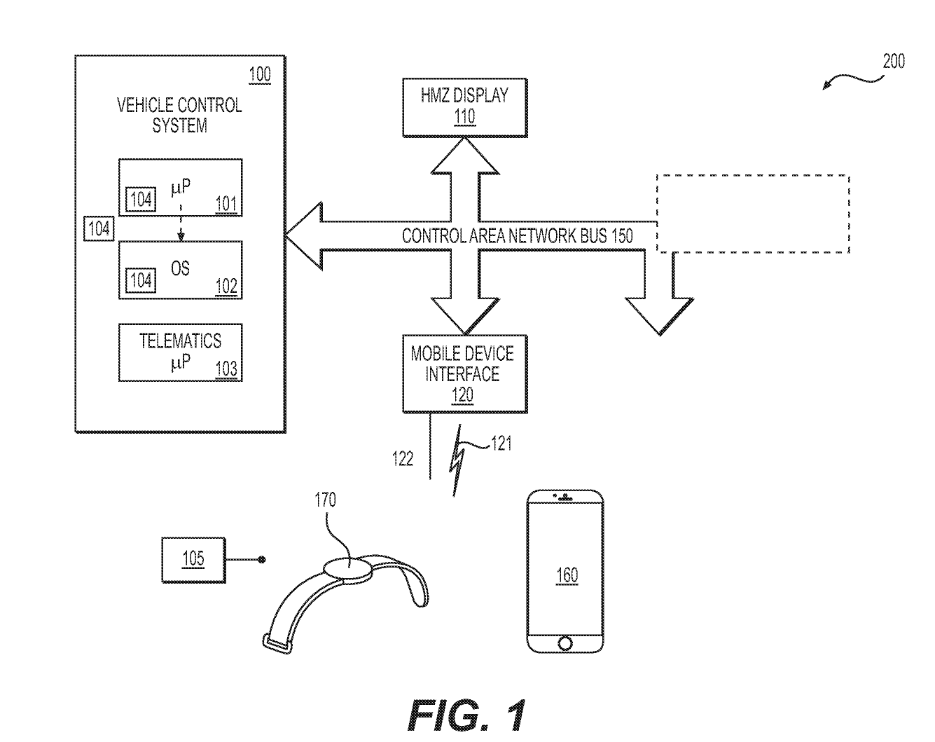

FIG. 1 illustrates an example of a vehicle electronic system 100 according to exemplary aspects disclosed herein. The vehicle electronic system 100 may be implemented as an infotainment system, which are known in the art, and commonly installed in vehicle subsystems. The aspects disclosed herein may be provided as a collection of instructions to modify an operating system of a vehicle control system 100, or alternatively, be already integrated into an operating system prior to installation and integration with the vehicle control system 100.

The vehicle control system 100 includes a processor 101, which may be any processor known in the vehicle-technology space provided to execute applications, receive inputs, and produce outputs to control a variety of vehicular sub-components. As explained above, the processor 101 may be provided with an operating system 102 installed on the processor 101. The operating system 102 is a series of instructions employed to run applications on the processor (either in the foreground or background), and allow either automated control of the vehicular sub systems, or direct control through engagement of either the driver or passenger in any of the provided HMI techniques.

Also included, or integrated with the vehicle control system 100 is a telematics processor 103 (or telematics control unit). A telematics processor 103 is a chipset installed in a vehicular control system 100 that allows the vehicular control system 100 to network connect (through wired or wireless connections) to variety of mobile devices (such as a portable mobile device, smart phones, tablets, laptops, and the like). A telematics processor 103 may be provided as an integrated circuit chip installed on a circuit board, the circuit board also hosting the processor 101.

The vehicle control system 100 may be provided with a HMI display 110. The vehicle system 110 may be coupled in a wired or wireless manner via a controller area network (CAN) bus 150 (or other manner in which to connect vehicular sub-components). A CAN bus is a vehicle bus standard designed to allow microcontrollers and devices to communicate with each other in applications without a host computer. It is a message-based protocol, designed originally for multiplex electrical wiring within automobiles, but is also used in many other contexts.

Not shown are the various other components in the vehicle, or commonly attached to a vehicle electronic network (such as a HVAC system, door locking system, instrument cluster, and the like). To explain the concepts associated with the aspects disclosed herein, the elements shown in FIG. 1 are sufficient.

Also shown is a mobile device interface 120. The mobile device interface 120 may be a port (or a plurality of ports) that allow one or more mobile devices, such as a wearable device 170 and a portable device 160 to couple to, and share information to and from the vehicle control system 100. The mobile device interface 120 may be provided with a wired connection 122 or a wireless connection 121, with a connection to the CAN bus 150 is facilitated by one or the other, or both.

Also shown in FIG. 1 is application 104. Application 104 will be described in further detail below, with various embodiments and combination of the embodiments being implementable to accomplish the aspects described herein. Application 104 (or primary application 104) may be installed as a stand-alone circuit or component in the vehicle control system 100, as part of microprocessor 101, or as an update to the OS 102 through installation via physical medium through a wired or wireless connection.

In addition to the aspects disclosed herein, a secondary application 105 is provided for the wearable device 170. The secondary application 105 may be pre-provided on the wearable device 170 during manufacture or installation, or provided as an updated version.

The aspects disclosed herein, allow a control of the portable device 160 with a wearable device 170, through mutual interaction with the vehicle control system 100. The vehicle control system 100 may be wired or wirelessly connected to both the portable device 160 and the wearable device 170.

The wearable device 170 may be configured to sense inputs through all known techniques associated with wearable technology. For example, the wearable device 170 may be included with a touch sensor, so a tap may be configured to instigate an action. Additionally, the wearable device 170 may be affixed with a motion sensor, with the motion sensor detecting shaking, or specific motion associated with an input. In another example, the wearable device 170 may be provided with a voice input, and accordingly, based on a voice input, the wearable device 170 may cause a specific action to occur.

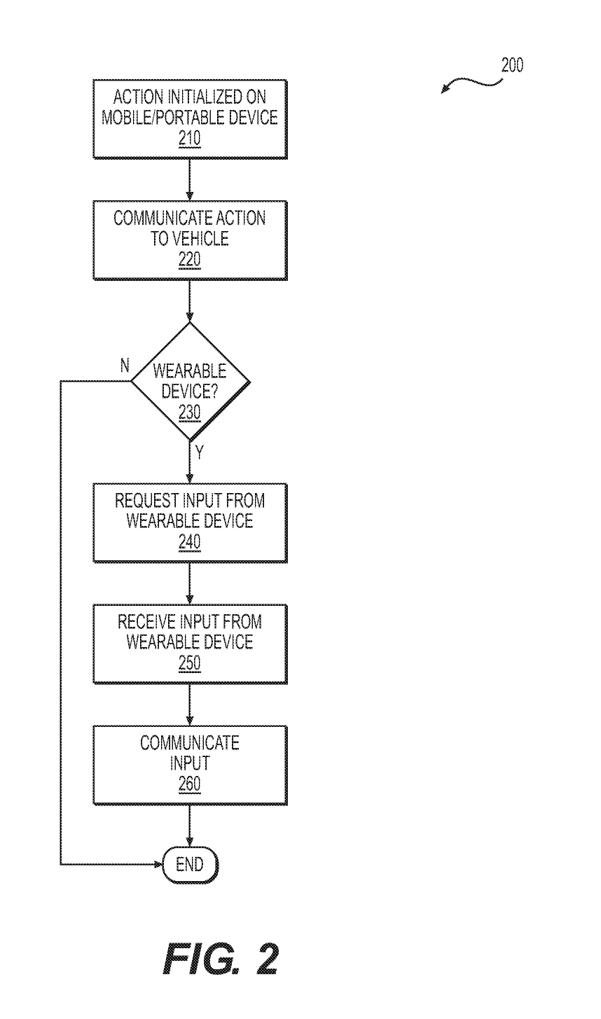

FIG. 2 illustrates a method 200 of implementing aspects associated with both application 104 and 105. As explained, in the implementation discussed herein, at least one portable device 160 is in a networked or handshaking relationship with a vehicular control system 100, and at least one wearable device 170 is also in a networked or handshaking relationship with the same vehicular control system 100.

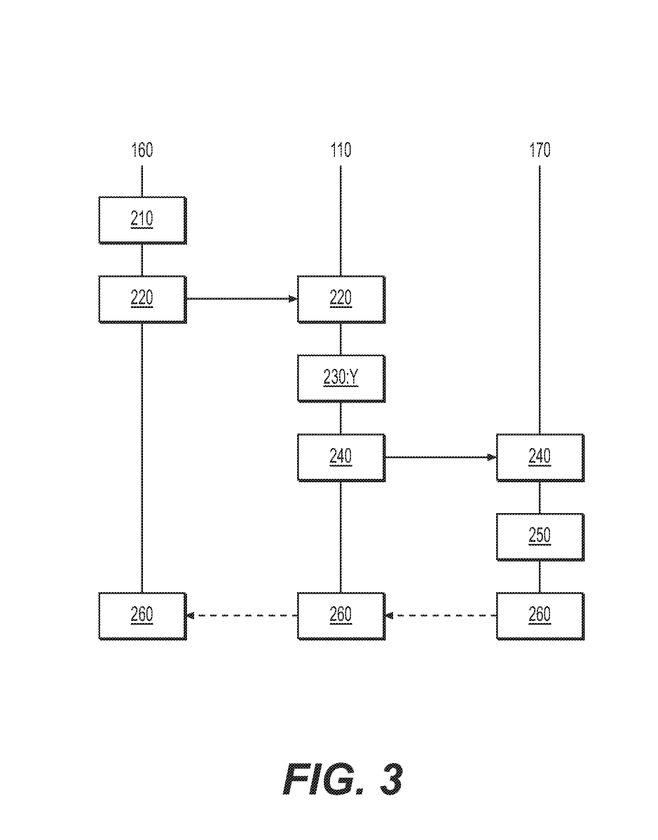

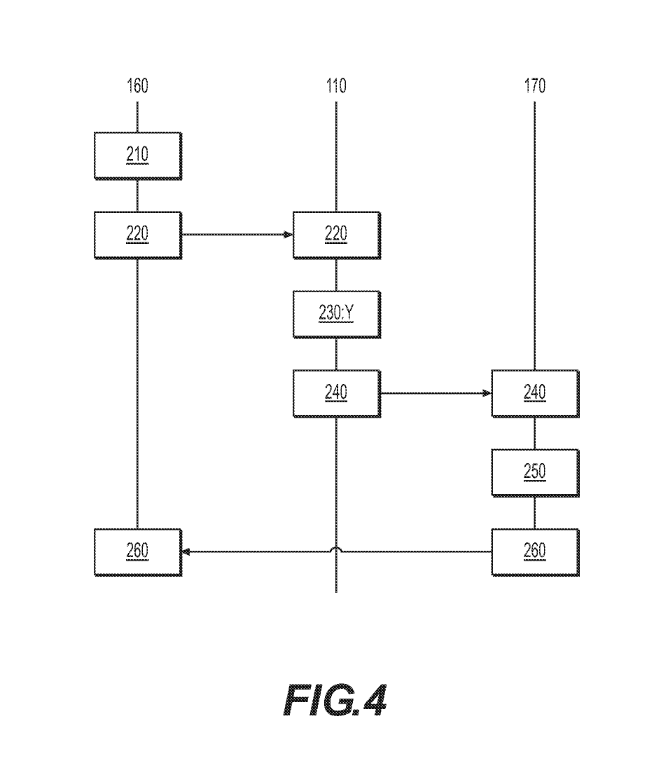

FIG. 2 also refers to both FIGS. 3 and 4, which are diagrams illustrating the various interoperable aspects associated with the devices shown in FIG. 1. FIGS. 3 and 4 are alternate embodiments, and as such, each may be individually implemented, or alternatively, a combination thereof may be used.

In operation 210, an action initiated on the portable device 210 is detected. This action may be in one example, a receiving of a call or communication. The action specifically is configured to communicate to the vehicular control system 100, and prompt said vehicular control system 100 for a response (operation 220).

After receiving the communication associated with the prompt requested for the action of operation 210 (via a telematics processor 103, via the mobile device interface 120), application 104 is configured to determine whether said communication is configured to be propagated to a wearable device 170 for a further response (operation 230). In one example, the vehicle control system 100 may also communicate the prompt to an HMI display 110, and employ any other interfaces associated with the vehicle control system 100.

In operation 240, if the answer to the determination in operation 230 is yes, a request is communicated to the wearable device 170. The wearable device 170 may be initiated to receive an input (through application 105). As such, the wearable device 170 may be programmed to enter a sensing mode, which allows interaction with the wearable device 170 is a predefined fashion to receive an input from the wearer.

Application 105 may be configured to provide a prompt, via any of the HMI techniques provided via the wearable device 170. For example, a wearable device 170 may vibrate, shake, light up, or display via the wearable device 170's screen that a call is being received.

At this juncture, the person wearing the wearable device 170 may interact with wearable device 170 through the prescribed manner (operation 250). For example, application 105 may be configured to require two taps of the wearable device 170 to answer a call, while one tap rejects a call.

In another example, the person wearing the wearable device 170 may shake the device, or raise their arm or appendage. In another example, the wearable device 170 may be equipped to receive a voice input in association with the prompt requested. In the examples noted above, the wearable device 170 is temporarily, for example for a predetermined amount of time, placed into a sensing mode, with the input to the sensing mode being at least any of the above-noted examples.

FIGS. 3 and 4 illustrate two different embodiments associated with the aftermath of operation 250. In operation 250, after the wearable device 170 is interacted with, data is communicated to either the mobile device 160 directly (FIG. 4) or the vehicle control system 100 (FIG. 3). In another embodiment, the wearable device 170 may communicate the answer to both the mobile device 160 and the vehicle control system 100.

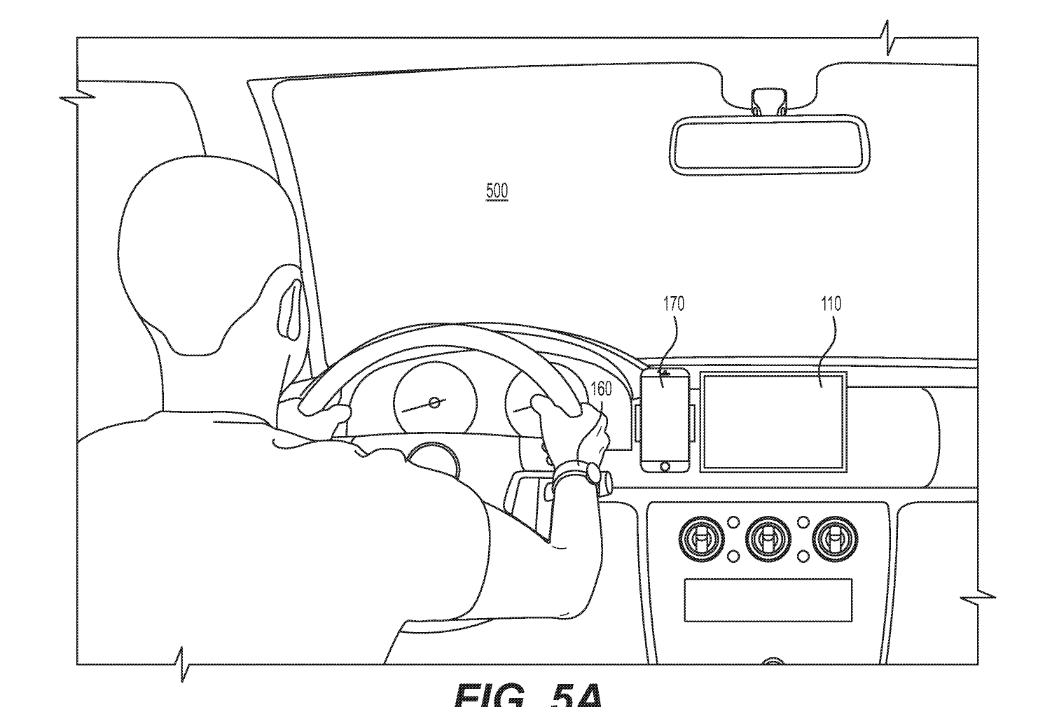

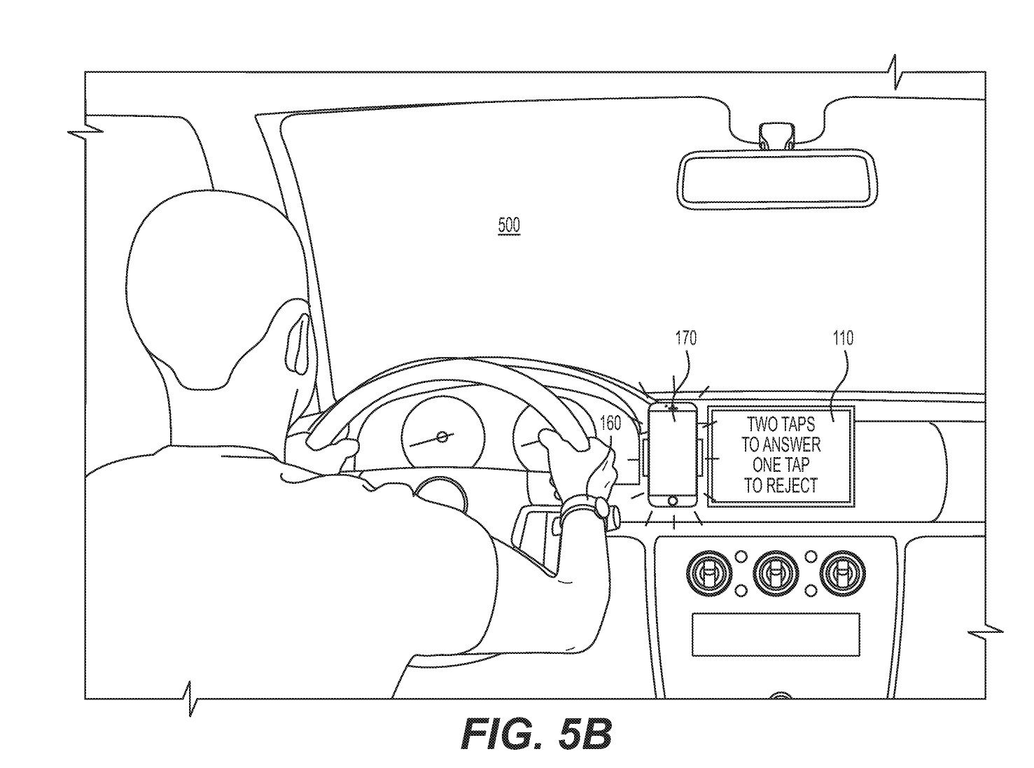

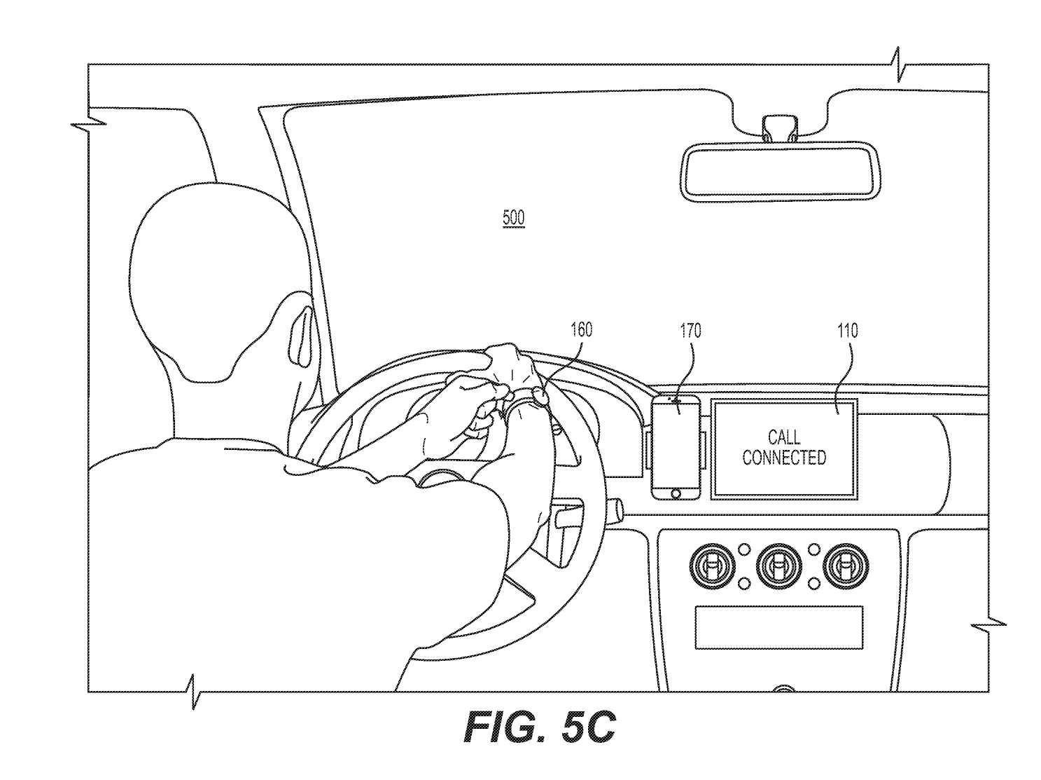

FIGS. 5(a-(c) illustrate an example implementation of the aspects described herein. In FIGS. 5(a-(c), a front-view of a vehicle 500 is shown. As shown in view 500, a mobile device 160 is mounted on a dashboard of the vehicle. Further, a driver is wearing a wearable device 170. To explain the concepts herein, it is assumed that the mobile device 160 is in a communicative relationship with vehicle control system 100 (not shown, but may be embedded in the electronics portion of the dashboard).

Also shown is an HMI display 110. As explained above, the HMI display 110 may be incorporated along with a vehicle infotainment device, and be installed in the centerstack portion of the vehicle's dashboard. This is exemplary, as HMI display's 110 may be incorporated with a variety of locations and contexts.

In FIG. 5(b), as shown by the vibration/lighted-up indicates around mobile device 170, a message is propagated to HMI display 110. In turn, the message provides instructions on how to interact with the wearable device 160 so as to control the mobile device 170. In the example shown, two taps answer the call and one tap rejects the call.

In FIG. 5(c), the user taps their wearable device 160, thereby controlling the mobile device 170. In one example, the signal is propagated back to the vehicle control system 100, and then communicated to the mobile device 170, thereby causing the mobile device 170 to either answer the call or reject the call (depending on the input provided). In another example, the wearable device 170 directly communicates with the mobile device 160.

Thus, employing aspects disclosed herein, a driver or passenger of a vehicle is provided a new way to interact with the various devices they may bring to the vehicle, and to those electronics already situated in a vehicle. Thus, according to the aspects disclosed herein, the occupant of the vehicle may realize an enhanced user experience, while potentially providing a safer driving experience.

Certain of the devices shown include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 2(a), (b), 5 and 6. The disclosed devices, components, and systems contemplate using or implementing any suitable technique for performing the steps illustrated in these figures. Thus, FIGS. 2(a), (b), 5 and 6 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for providing a vehicle-based human-machine interface (HMI) via a wearable device, comprising:
a vehicle microprocessor network connected to the wearable device and a mobile device;
a data store comprising a non-transitory computer readable medium storing a program of instructions for the providing;
a processor that executes the program of instructions, the instruction comprising the following steps:
via the mobile device, initializing an action associated with a prompt;
via the mobile device, communicating data associated with the prompt to the vehicle control system;
via the vehicle processor, determining whether the prompt in the data is communicable to the wearable device;
via the vehicle processor, and in response to the determination being yes, communicating the data to the wearable device;
via the wearable device, receiving an input in response to the prompt, and
via the wearable device, communicating the received input.

2. The system according to claim 1, further comprising:
a first application installed on the vehicle processor and a second application installed on the wearable device, wherein the program instructions performed via the vehicle processor and integrated into the first application, and the program instructions performed via the wearable device are integrated into the second application.

3. The system according to claim 1, wherein the prompt is generated in response to the mobile device receiving a call, and the prompt is further defined as whether to answer the call.

4. The system according to claim 1, wherein the program of instructions further comprises changing a mode of the wearable device to enter a sensing mode in response to the communication of data to the wearable device.

5. The system according to claim 4, further comprising:
a human-machine interface (HMI) display electronically coupled to the vehicle processor;
after entering the sensing mode, simultaneously displaying via the HMI instructions on interacting with the wearable device to respond to the prompt.

6. The system according to claim 5, wherein the response to the prompt is defined as a number of taps on a screen associated with the wearable device.

7. The system according to claim 5, wherein the response to the prompt is defined as a vocal input.

8. The system according to claim 5, wherein the response to the prompt is defined as a movement of an appendage on which the wearable device is worn on.

9. The system according to claim 1, wherein the communication of the received input is defined as a communication to the mobile device, via the vehicle processor.

10. The system according to claim 1, wherein the communication of the received input is defined as a communication to the mobile device directly through a pairing connection established via the wearable device and the mobile device.

11. A system for controlling a vehicle-based human-machine interface (HMI) via wearable technology, comprising:
a vehicle microprocessor network connected to the wearable technology and a mobile device;
a data store comprising a non-transitory computer readable medium storing a program of instructions for the controlling;
a processor that executes the program of instructions, the instruction comprising the following steps:
receiving from a vehicle processor, data associated with a prompt;
providing an interface technique with the wearable device to answer the prompt; and
communicating an answer via the interface technique to the vehicle processor.

12. The system according to claim 11, wherein the answer to prompt is employed to control a mobile device in a pairing networked relationship with the vehicle processor.

13. The system according to claim 11, wherein the answer to the prompt is defined as a number of taps on a screen associated with the wearable device.

14. The system according to claim 11, wherein the answer to the prompt is defined as a vocal input.

15. The system according to claim 11, wherein the answer to the prompt is defined as a movement of an appendage on which the wearable device is worn on.

16. The system according to claim 11, wherein the communication of the received answer is defined as a communication to the mobile device, via the vehicle processor.

17. The system according to claim 11, wherein the communication of the received answer is defined as a communication to the mobile device directly through a pairing connection established via the wearable device and the mobile device.

18. A system for modifying a vehicle processor to allow control via a wearable device, comprising:
a vehicle microprocessor network connected to the wearable device and a mobile device;
a data store comprising a non-transitory computer readable medium storing a program of instructions for the providing;
modifying the program of instructions to execute via the vehicle processor to further comprise the following steps:
in response to the vehicle processor receiving data requesting an answer to a prompt, determining whether the wearable device is employable to provide the answer;
in response to the determination being yes, communicating the data including the prompt to the wearable device; and
receiving data from the wearable device including the answer to the prompt.
